(19) United States
(12) Patent Application Publication
(10) Pub. No.: US 2010/0053332 A1
(43) Pub. Date: Mar. 4, 2010

(54) FRUSTRATED INTERNAL REFLECTION UNCOOLED INFRARED CAMERA

(75) Inventor: Mark Alan Massie, Santa Ynez, CA (US)

Correspondence Address: FELIX L. FISCHER, ATTORNEY AT LAW, 1607 MISSION DRIVE, SUITE 204, SOLVANG, CA, 93463, US

(73) Assignee: NOVA RESEARCH, INC., Solvang, CA (US)

(21) Appl. No.: 12/548,173

(22) Filed: Aug. 26, 2009

Related U.S. Application Data
(60) Provisional application No. 61/092,144, filed on Aug. 27, 2008.

(51) Int. Cl. H04N 5/33

(52) U.S. Cl. 348/164; 348/E05.09

(57) ABSTRACT

A longwave infrared (LWIR) camera system incorporates a prism having a reflecting face with an internal surface and an external surface, an input face and an output face. A visible light source provides light to the prism input face and an image detector is positioned to receive light from the prism output face. A plurality of bi-metal cantilevers are arranged in a MEMS array immediately adjacent the external surface of the reflecting face of the prism. Each of the bi-metal cantilever deflects based on absorbed infrared energy to contact the outer surface of the reflecting face. A CMOS image sensor is employed as the image detector. An infrared energy wavefront from a source impinging on the MEMS structure results in energy absorbtion by the MEMS elements corresponding to the energy distribution of the wavefront with each of the MEMS elements contacting the prism reflecting face outer surface for frustration of the total internal reflection from the light source providing a infrared induced modulation of the visible light wavefront impinging on the CMOS image sensor.

### REFERENCE TO RELATED APPLICATIONS

This application claims priority of U.S. provisional application Ser. No. 61/092,144 filed on Aug. 27, 2008 by inventor Mark Alan Massie entitled FRUSTRATED INTERNAL REFLECTION UNCOOLED INFRARED CAMERA the disclosure of which is incorporated herein by reference.

### BACKGROUND OF THE INVENTION

1. Field of the Invention

This invention relates generally to the field of Infrared cameras and more particularly to a camera architecture employing frustrated total internal reflection for image input into a CMOS imager.

2. Description of the Related Art

Current uncooled IR technology for camera use is about Noise Equivalent Differential Temperature (NEDT) of 35 mK, pixel pitch of 17 to 25 micrometers, time constant 10 milliseconds, F-number of F/1, illuminated at 300 K over the spectral bandwidth between 8 um and 12 um. NEDT is noise divided by Responsivity. A limiting component of Responsivity is the conversion sensitivity (a) which may be defined as (1/x)(dx/dT). In the case of a resistor, “x” is the resistance of the detector. For vanadium oxide, a has been reported as about 2.5%. The current technology is limited in conversion sensitivity by the temperature coefficient of resistance (TCR) of about 2.5% and a combination of noise sources arising from the use of bolometer detectors that are sampled or biased with an electric current.

It is therefore desirable to provide large improvements in conversion sensitivity and noise that will lead to the elimination of electrically biased and sampled bolometer readout combination. It is also desirable to provide optically read/sampled detectors that address minimizing Shot noise or other noise inherent in the optical probe beam to make direct viewing or collection with a CCD array without large well capacities feasible.

It is further desirable to provide improved performance resulting from better adjustable time constant and responsivity by electrical or mechanical means, reset ability to limit memory to allow for trading sensitivity for response speed under control of the user.

### SUMMARY OF THE INVENTION

The present invention provides a longwave infrared (LWIR) camera system which incorporates a prism having a reflecting face with an internal surface and an external surface, an input face and an output face. A visible light source provides light to the prism input face and an image sensor is positioned to receive light from the prism output face. A plurality of elements are arranged in a matrix immediately adjacent the external surface of the reflecting face of the prism. Each of the elements is adjustable to contact the external surface responsive to impingement of infrared radiation.

For an exemplary embodiment, the matrix is provided by a MEMS structure having bi-metal cantilever which deflects based on absorbed infrared energy to contact the outer surface of the reflecting face. A CMOS image sensor is employed as the image detector providing an inexpensive and readily available detector.

### BRIEF DESCRIPTION OF THE DRAWINGS

These and other features and advantages of the present invention will be better understood by reference to the following detailed description when considered in connection with the accompanying drawings wherein:

FIG. 1 is a side view of a prism internally reflecting light from a source;

FIG. 2 is a side view of the prism of FIG. 1 with contact of an outer surface of the reflecting face by a material element resulting in frustration of the total internal reflection;

FIG. 3 is a side view of an exemplary structure of the present invention showing a MEMS array adjacent the reflecting face;

FIG. 4 is a top view of a portion of the MEMS array showing an individual pixel element; and,

FIG. 5 is a side view of the bi-metal cantilever in each pixel element of the MEMS array.

### DETAILED DESCRIPTION OF THE INVENTION

The infrared camera system disclosed in the embodiments herein makes use of a conventional silicon CMOS imager, a simple prism and a “micro electromechanical structure” (MEMS). The property of “Frustrated Total Internal Reflection” is used in conjunction with a MEMS array to permit a conventional, visible-light CMOS imaging chip to report the infrared image of a scene.

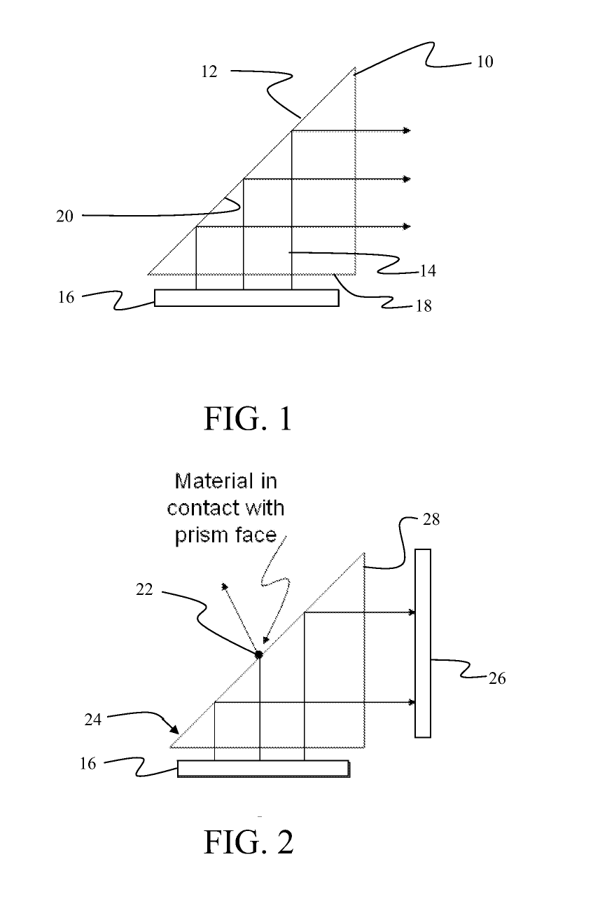

FIG. 1 shows how a conventional prism is used to produce Total Internal Reflection (TIR). Looking into the edge of the prism 10, reflecting face 12 acts as though it were a mirror, reflecting all of the visible light energy 14 from a light source 16 received through input face 18 and imposed upon the internal surface 20 of the reflecting face.

As shown in FIG. 2 if a material element 22 is placed in contact with an outer surface 24 of the reflecting face of the prism the known phenomenon results that light energy will be coupled out of the prism reflecting face at that specific location. In effect, the material causes a reduction in the amount of internally reflected visible energy. An image sensor 26 is used to sample the reflected wavefront exiting an output face 28 in this configuration. In an exemplary prior art use, a person puts his/her finger on the prism's face, providing the material contact with the outer surface and fingerprints may be digitally captured by the image sensor.

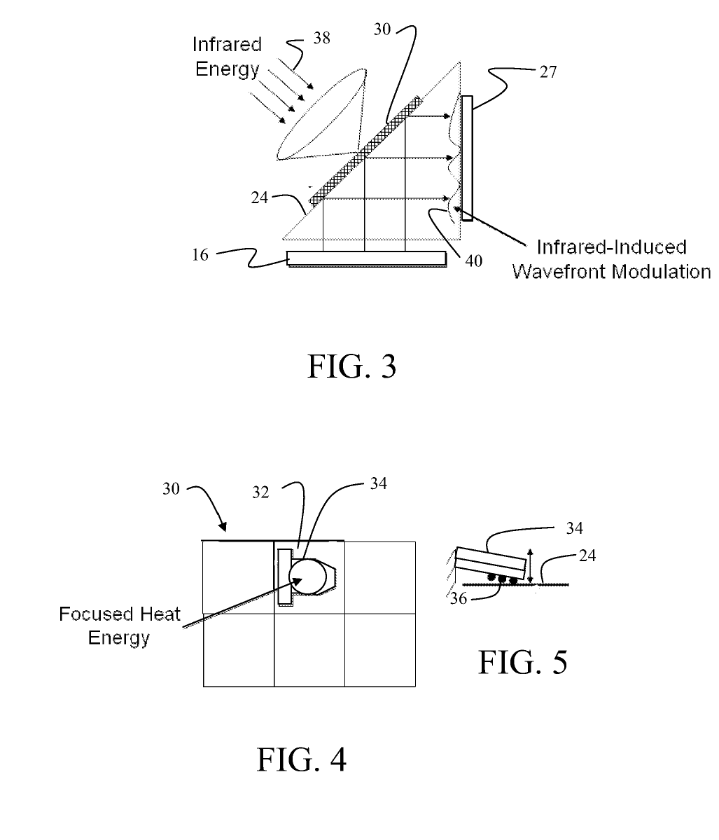

Referring to FIG. 3, a visible-light sensitive CMOS image detector 27 is provided as an imaging sensor. A specialized micro electrical machine system (MEMS) structure 30 is mounted in proximity to the outer surface 24 of the face of the prism having individual elements 32 corresponding to a per-pixel matching in the CMOS image detector 27 and with the ability to apply a variable contact area on the outer surface of the face in response to absorbed heat energy.

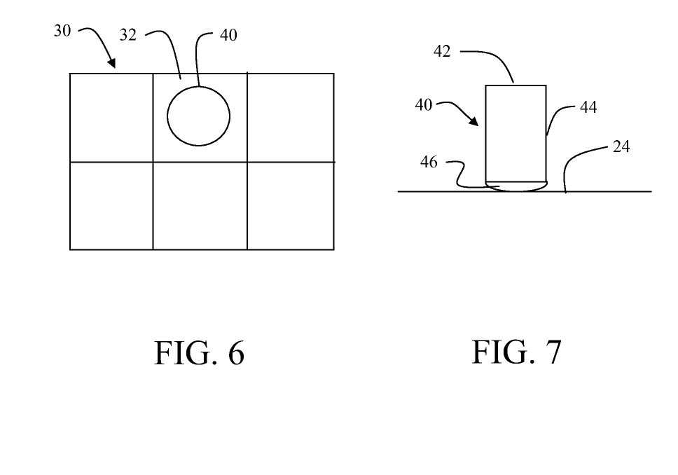

As shown in FIGS. 4 and 5, each of the MEMS elements 32 incorporates a bi-metal cantilever 34 which deflects in response to absorbed heat energy. An IR lens system is employed to focus the incoming IR onto the MEMS elements. The deflection of the cantilever results in varying contact with the outer surface of the prism reflecting face thereby adjusting the internal reflection at that pixel point. As shown in FIG. 5, for the exemplary embodiment placement of small beads 36 on the lower surface of the cantilever provides a quantitative increase in contact area with bending force as each bead is brought into contact with the outer surface 24 of the prism. In alternative embodiments other means for changing the contact area in response to absorbed infrared energy could be employed for adjusting the level of frustration of total internal reflection in the prism. As an example, an array of micro-Golay cells (which expand their respective volumes in response to absorption of infrared energy, thereby changing the contact area to the prism face). As shown in FIGS. 6 and 7, the micro-Golay cells 40 each employ an infrared heating surface 42. Xenon gas in the cylindrical body 44 of the cell expands deforming a diaphragm 46 at the opposite end of the chamber from the heating surface. Impingement of the diaphragm on the prism outer surface 24 then creates the frustrated total reflection. As with the cantilever structure, the expanding contact area of the deforming diaphragm changes the level of frustration of total internal reflection of the prism.

An infrared energy wavefront from a source (generally depicted in FIG. 3 as element 38) impinging on the MEMS structure 30 results in energy absorption by the MEMS elements 32 corresponding to the energy distribution of the wavefront. The corresponding reaction of bi-metal cantilevers 34 the MEMS elements 32 contacting the prism reflecting face outer surface 24 results in frustration of the total internal reflection from the light source providing a infrared induced modulation of the visible light wavefront 40 impinging on the CMOS image sensor 26 which is then available for processing. A longwave infrared (LWIR) camera system is created by this structure. This new type of infrared camera provides numerous advantages in terms of low cost, large format and small size permitting a conventional, visible-light CMOS imaging chip to report the infrared image of a scene.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A longwave infrared (LWIR) camera system comprising:
a prism having an reflecting face with an internal surface and an external surface, an input face and an output face;
a visible light source providing light to the prism input face;
an image sensor positioned to receive light from the prism output face;
a plurality of elements arranged in a matrix proximate the external surface of the reflecting face of the prism, each of said elements having adjustable surface area contacting the external surface responsive to impingement of infrared radiation.

2. The LWIR camera system of claim 1 wherein the image sensor employs a pixel structure with a plurality of elements in a matrix positioned to correspond to a one to one matching with pixels in the image sensor.

3. The LWIR camera system of claim 2 wherein the plurality of elements comprise bi-metal cantilevers.

4. The LWIR camera system of claim 2 wherein the plurality of elements comprise micro-Golay cells

5. The LWIR camera system of claim 3 further comprising a plurality of impingement balls spaced along a bottom surface of each cantilever, each ball contacting the external surface responsive to a proportional increase in bending of the cantilever.

6. The LWIR camera system of claim 2 wherein the image sensor is a CMOS image detector.

7. The LWIR camera system of claim 3 wherein the bi-metal cantilevers are incorporated in a MEMs structure.

8. A method for longwave infrared image detection comprising the steps of:
providing a prism having an reflecting face with an internal surface and an external surface, an input face and an output face;
providing light to the prism input face;
providing an image sensor positioned to receive light from the prism output face;
arranging a plurality of elements in a matrix proximate the external surface of the reflecting face of the prism;
adjustably contacting the external surface with each element responsive to impingement of infrared radiation to frustrate total reflection;
sensing an infrared induced modulation of the visible light wavefront with the image sensor.
